(19) United States
(12) Patent Application Publication
(10) Pub. No.: US 2012/0210381 A1
(43) Pub. Date: Aug. 16, 2012

(54) DISTRIBUTION SYSTEM, GATEWAY, DISTRIBUTION METHOD, AND PROGRAM

(75) Inventor: Kazunori Ozawa, Tokyo (JP)

(73) Assignee: NEC CORPORATION, Tokyo (JP)

(21) Appl. No.: 13/502,937

(22) PCT Filed: Oct. 21, 2010
(86) PCT No.: PCT/JP2010/068620

§ 371 Date: Apr. 19, 2012

(30) Foreign Application Priority Data
Oct. 23, 2009 (JP) 2009-244550

(51) Int. Cl. H04N 7/173

(52) U.S. Cl. 725/114

(57) ABSTRACT

A distribution system includes a gateway that, if a content temporary storage device does not store a moving image stream or moving image file that can be read, requests an external distribution server to transmit moving image content specified by a request message, generates a plurality of moving image streams or moving image files including a moving image stream or moving image file which has a bit rate receivable by the content requesting terminal and equal to or lower than a bit rate obtained from the bearer QoS information, transmits the moving image stream or moving image file, which has a bit rate receivable by the content requesting terminal and equal to or lower than a bit rate obtained from the bearer QoS information, to the terminal, and stores the plurality of generated moving image streams or moving image files in a predetermined content temporary storage device.

### CROSS-REFERENCE TO RELATED APPLICATIONS

The present invention claims priority from Japanese Patent Application 2009-244550 (filed on Oct. 23, 2009) the content of which is hereby incorporated in its entirety by reference into this specification.

### TECHNICAL FIELD

The present invention relates to a distribution system, a gateway, a distribution method, and a program, and more particularly to a distribution system that has a storage device in which moving image content is temporarily stored, a gateway, a distribution method, and a program.

### BACKGROUND ART

With the increase in speed and capacity of the mobile network, content distribution with mobile terminals as the destination becomes increasingly popular. The speed and capacity of the mobile network will be further increased in future by technologies such as LTE(Long Term Evolution) and EPC(Evolved Packet Core).

In content distribution where mobile terminals are the destination as described above, we must consider the ability of the mobile terminals. For example, Patent Document 1 discloses a gateway server that converts content, received from a content server, to a format compatible with the display ability of a small terminal and then distributes the converted content to the small terminal.

Patent Document 2 discloses a server device that analyzes a content transmission request received from a client terminal, processes content so that it becomes compatible with the screen display ability of the client terminal, and transmits the processed content to the client terminal.

Patent Documents 3 and 4 disclose an information management server (R2M: RADIUS & Repository Manager) and an application gateway. The information management server generates profile information when a mobile terminal (UE) acquires content wherein the profile information is composed of the user agent information, user information (User-Profile), selfcare information (Selfcare-Profile), and mobile terminal information (UE-Profile) on the mobile terminal. The application gateway converts content, which is acquired from the origin server in response to a content requesting request (HTTP Req) transmitted by a mobile terminal, by referencing the parameters included in the profile information indicating the performance and ability of the mobile terminal so that the performance and the ability of the mobile terminal are maximized.

Patent Document 5 discloses a server that collects the client attribute information and the network bandwidth information, converts a stream, which is used for content distribution, to the optimized distribution-coding format and distribution bit rate, and transmits the converted stream.

Patent Document 6 discloses a content providing server comprising file generation means that generates the same content in two or more different file formats, storage means that stores a content file obtained by the file generation means, metadata generation means that creates metadata on the content based on the semantic information on the content, and publishing means that publishes metadata, obtained by the metadata generation means, to allow the client terminal to browse it via the communication network. This configuration allows the client terminal to easily reproduce and view content.

### PRIOR ART DOCUMENT

### Patent Document

[Patent Document 1]
Japanese Patent Publication Kokai No. JP2001-195330A
[Patent Document 2]
Japanese Patent Publication Kokai No. JP2001-236202A
[Patent Document 3]
Japanese Patent Publication Kokai No. JP2005-275534A
[Patent Document 4]
Japanese Patent Publication Kokai No. JP2005-277527A
[Patent Document 5]
Japanese Patent Publication Kokai No. JP2005-318057A
[Patent Document 6]
Japanese Patent Publication Kokai No. JP2007-129636A

### DISCLOSURE OF THE INVENTION

### Problems to be Solved by the Invention

The entire disclosures of the above-mentioned Patent Documents are hereby incorporated by reference into this specification. The following analysis is given from a viewpoint of the present invention.

As pointed out in above-mentioned Patent Documents 1-6, if coded information generated by coding content and the ability information on a terminal do not match when the content is received and displayed on various terminals such as a mobile phone, a PDA (Personal Digital Assistant), and a game terminal, the decoding of a moving-image stream becomes difficult sometimes with a result that the content cannot be displayed or the image is distorted. In addition, a mismatch in the bit rate, resolution, codec, file format, and protocol may even prevent the terminal from decoding.

To solve this problem, the above-mentioned Patent Documents 1-6 disclose technologies for converting content via a gateway and so on. However, when there are many terminals to which content is to be distributed or when many requests are issued from many terminals to popular contents, distribution wait time (TAT) becomes long or QoS (Quality of Service) of the mobile network between the distribution server and the terminal cannot be assured, entailing traffic congestion and packet loss, resulting in a problem of decreasing service usability.

In addition, the problem with the technology disclosed in Patent Document 1 is that the technology is designed merely for conversion by a small terminal, offering a problem that conversion by various types of terminals cannot be performed. The problem with the method disclosed in Patent Document 2 and Patent Document 5 is that the method performs conversion on the premise that the client has a function to transmit the screen display ability or the attribute information (In Patent Document 5, the characteristics of the video/audio decoding unit or the video-display/audio-output unit are defined as the attribute information. See paragraph 0012) and, therefore, the method cannot perform predetermined conversion for a terminal not having the function to transmit this information. The problem with the method disclosed in Patent Document 3 and Patent Document 4 is that the profile information must be prepared for each user terminal. The problem with the method disclosed in Patent Document 6 is that the client must browse metadata and issue an acquisition request.

In view of the foregoing, it is an object of the present invention to provide a distribution system, a gateway, a distribution method, and a program in which, even when there are many terminals to which content is to be distributed or when many terminals issue requests for particular content, content can be distributed suitably according to the ability of each terminal and, in addition, there is no need for the terminal to transmit the screen display ability or the attribute information.

### Means to Solve the Problems

According to a first aspect of the present invention, there is provided a distribution system comprising a gateway that comprises: an ability information storage unit that stores terminal device type information, included in a content request message, and ability information on an ability of a terminal of the device type to receive moving image content, the device type information being stored in association with the ability information; a control signal transmission/reception unit that reads a moving image stream or moving image file from a predetermined content temporary storage device based on ability information obtained from device type information and bearer QoS information acquired from a packet forwarding device, the device type information included in a request message received from a content requesting terminal via the packet forwarding device, the moving image stream or moving image file having a bit rate receivable by the content requesting terminal and equal to or lower than a bit rate obtained from the bearer QoS information; a conversion unit that performs required conversion for a moving image stream or moving image file received from an external distribution server by referencing information stored in the ability information storage unit, the moving image file storing the moving image stream; and a packet transmission unit that transmits a moving image stream or moving image file read from the predetermined content temporary storage device or converted by the conversion unit. If the content temporary storage device does not store a moving image stream or moving image file that can be read, the gateway requests the external distribution server to transmit moving image content specified by the request message; instructs the conversion unit to generate a plurality of moving image streams or moving image files including a moving image stream or moving image file which has a bit rate receivable by the content requesting terminal and equal to or lower than a bit rate obtained from the bearer QoS information; transmits the moving image stream or moving image file, which has a bit rate receivable by the content requesting terminal and equal to or lower than a bit rate obtained from the bearer QoS information, to the terminal; and stores the plurality of generated moving image streams or moving image files in the predetermined content temporary storage device.

According to a second aspect of the present invention, there is provided a gateway, comprising: an ability information storage unit that stores terminal device type information, included in a content request message, and ability information on an ability of a terminal of the device type to receive moving image content, the device type information being stored in association with the ability information; a control signal transmission/reception unit that reads a moving image stream or moving image file from a predetermined content temporary storage device based on ability information obtained from device type information and bearer QoS information acquired from a packet forwarding device, the device type information included in a request message received from a content requesting terminal via the packet forwarding device, the moving image stream or moving image file having a bit rate receivable by the content requesting terminal and equal to or lower than a bit rate obtained from the bearer QoS information; a conversion unit that performs required conversion for a moving image stream or moving image file received from an external distribution server by referencing information stored in the ability information storage unit, the moving image file storing the moving image stream; and a packet transmission unit that transmits a moving image stream or moving image file read from the predetermined content temporary storage device or converted by the conversion unit. If the content temporary storage device does not store a moving image stream or moving image file that can be read, the gateway requests the external distribution server to transmit moving image content specified by the request message; instructs the conversion unit to generate a plurality of moving image streams or moving image files including a moving image stream or moving image file which has a bit rate receivable by the content requesting terminal and equal to or lower than a bit rate obtained from the bearer QoS information; transmits the moving image stream or moving image file, which has a bit rate receivable by the content requesting terminal and equal to or lower than a bit rate obtained from the bearer QoS information, to the terminal; and stores the plurality of generated moving image streams or moving image files in the predetermined content temporary storage device.

According to a third aspect of the present invention, there is provided a distribution method, performed by the gateway described above. That is, there is provided a content distribution method, performed by the gateway described above comprising: if the content temporary storage device does not store a moving image stream or moving image file that can be read, requesting the external distribution server to transmit moving image content specified by the request message; instructing the conversion unit to generate a plurality of moving image streams or moving image files including a moving image stream or moving image file which has a bit rate receivable by the content requesting terminal and equal to or lower than a bit rate obtained from the bearer QoS information; transmitting the moving image stream or moving image file, which has a bit rate receivable by the content requesting terminal and equal to or lower than a bit rate obtained from the bearer QoS information, to the terminal; and storing the plurality of generated moving image streams or moving image files in the predetermined content temporary storage device. This method is associated with a particular machine called the gateway described above.

According to a fourth aspect of the present invention, there is provided a program causing a computer, which configures the gateway described above, to perform processings. This program causes a computer to perform the processings of: if the content temporary storage device does not store a moving image stream or moving image file that can be read, requesting the external distribution server to transmit moving image content specified by the request message; instructing the conversion unit to generate a plurality of moving image streams or moving image files including a moving image stream or moving image file which has a bit rate receivable by the content requesting terminal and equal to or lower than a bit rate obtained from the bearer QoS information; transmitting the moving image stream or moving image file, which has a bit rate receivable by the content requesting terminal and equal to or lower than a bit rate obtained from the bearer QoS information, to the terminal; and storing the plurality of generated moving image streams or moving image files in the predetermined content temporary storage device. This program may be recorded on a computer readable storage medium. That is, the present invention may also be implemented as a computer program product.

### Effect of the Invention

The present invention allows content to be distributed suitably according to the ability of individual terminals even when there are many terminals to which content(s) is to be distributed or when accesses from many terminals concentrate on particular content. In addition, the present invention eliminates the need for a terminal to transmit the screen display ability or attribute information. The reason is that the present invention uses the device type information included in a request message transmitted when making a content distribution request and, at the same time, provides a content temporary storage device that stores converted content. This configuration allows content to be distributed from the content temporary storage device in response to a distribution request from a terminal of the same device type.

### BRIEF DESCRIPTION OF THE DRAWINGS

FIG. 1 is a block diagram showing the connection configuration of a first exemplary embodiment of the present invention.

FIG. 2 is a block diagram showing the configuration of a gateway in the first exemplary embodiment of the present invention.

FIG. 3 is a block diagram showing the connection configuration of a second exemplary embodiment of the present invention.

### PREFERRED MODES FOR CARRYING OUT THE INVENTION

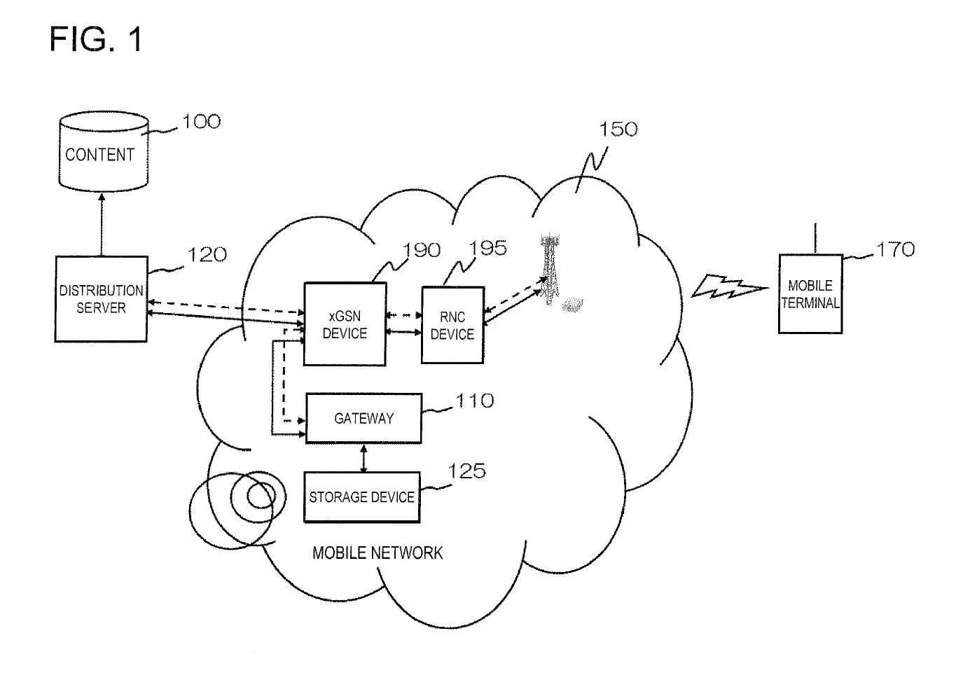

First, the outline of the present invention will be described below. The present invention is implemented by the configuration such as the one shown in FIG. 1 in which a gateway 110 and a storage device 125, which functions as a content temporary storage device, are provided on a mobile network 150 via which content is distributed to a mobile terminal 170. The storage device 125 need not be a device standalone from the gateway 110; for example, the storage device 125 may be implemented by a memory or an auxiliary storage device built in the gateway 110.

When a content request message is received from the mobile terminal 170 via a packet-forwarding device (corresponding to a xGSN device 190 in FIG. 1), the gateway 110 of the present invention acquires the terminal device type information and the content information included in the request message to check if a compression-encoded moving image stream or moving image file, which corresponds to the content information and is receivable by the content requesting terminal identified by the device type information, is stored in the storage device 125. In addition, the gateway 110 of the present invention has the function to acquire the bit rate, obtained from the QoS (Quality of Service) information of the bearer, from the packet-forwarding device to check if the moving image stream or moving image file, stored in the storage device 125, exceeds the bit rate obtained from the packet-forwarding device.

If it is found, as the result of the checking, that a compression encoded moving image stream or moving image file, which corresponds to the content information and is receivable by the content requesting terminal identified by the device type information, is stored in the storage device 125 and that the bit rate is equal to or lower than the bit rate obtained from the packet forwarding device, the gateway 110 reads the moving image stream or moving image file from the storage device 125 and transmits it to the mobile terminal 170 via the packet forwarding device.

On the other hand, if it is found, as the result of the checking, that a compression encoded moving image stream or moving image file, which corresponds to the content information and is receivable by the content requesting terminal identified by the device type information, is not stored in the storage device 125 or if the bit rate of the moving image stream or moving image file exceeds the bit rate obtained from the packet forwarding device, the gateway 110 requests the distribution server 120 to transmit the content and, as necessary, performs conversion corresponding to the reception ability of the terminal based on the device type information of the terminal and on the bit rate obtained from the packet forwarding device and, after that, transmits the moving image stream or moving image file to the mobile terminal 170 via the packet forwarding device. Furthermore, in addition to the moving image stream or moving image file transmitted to the mobile terminal 170, the gateway 110 generates moving image streams or moving image files, with changes added to the bit rate and so on, at the conversion time and stores the multiple generated moving image streams or stream files in the storage device 125.

Thereafter, when the same content is requested by the mobile terminal 170 of the same type or when the same content is requested by a terminal capable of receiving the generated moving image streams or moving image files, the moving image streams or moving image files stored in the storage device 125 may be read for distribution. Therefore, even when there are many terminals to which content is to be distributed or when requests from many terminals concentrate on popular content, the configuration of the present invention prevents the distribution wait time (TAT) from becoming long or congestion or packet loss in the mobile network 150 from being generated.

As the bit rate obtained from the packet forwarding device, the maximum bit rate (MBR: Maximum Bit Rate) or the guaranteed bit rate (GBR: Guaranteed Bit Rate) that the xGSN device 190, which works as the packet forwarding device, sets in the RNC device 195 may be used. Based on the maximum bit rate information and/or the guaranteed bit rate information, the gateway 110 checks if the bit rate of the moving image stream or moving image file to be distributed does not exceed any of the maximum bit rate and the guaranteed bit rate, thus more reliably preventing congestion or packet loss in the mobile network 150 from being generated.

In the present invention, the following modes are possible.

### [First Mode]

See the distribution system in the first aspect above.

### [Second Mode]

Preferably, the gateway further comprises a selection unit that selects a moving image stream or moving image file, which has a highest bit rate not exceeding a bit rate obtained from the bearer QoS information, when the control signal transmission/reception unit reads a moving image stream or moving image file, which has a bit rate receivable by the content requesting terminal and equal to or lower than a bit rate obtained from the bearer QoS information, from the predetermined content temporary storage device.

### [Third Mode]

Preferably, the gateway receives a maximum bit rate and/or a guaranteed bit rate from the packet forwarding device as the bearer QoS information.

### [Fourth Mode]

Preferably, when the ability information further includes a bit rate, a codec, a screen resolution, and a frame rate receivable by a terminal of the device type,

a transcoder unit, which generates a stream or a file compatible with the ability information, is provided as the conversion unit.

### [Fifth Mode]

Preferably, when the ability information further includes at least one of a file format, a file size, and a protocol receivable by a terminal of the device type,

a file conversion unit, which performs file conversion, or a protocol conversion unit, which performs protocol conversion, is provided as the conversion unit, wherein the file conversion or the protocol conversion is performed to ensure compatibility with the ability information.

### [Sixth Mode]

The packet forwarding device may be an xGSN(Serving/Gateway GPRS Support Node) device on a mobile packet network or an S/P(Serving/Packet Data) gateway on a mobile EPC(Evolved Packet Core) network.

### [Seventh Mode]

Preferably, as the plurality of moving image streams or moving image files that the gateway instructs the conversion unit to generate if the content temporary storage device does not store a moving image stream or moving image file having a bit rate receivable by the content requesting terminal and equal to or lower than a bit rate obtained from the bearer QoS information,

the gateway instructs the conversion unit to generate a moving image stream or moving image file having a bit rate receivable by the content requesting terminal and equal to or lower than a bit rate obtained from the bearer QoS information and moving image streams or moving image files each having a bit rate or frame rate different from the bit rate or frame rate of the moving image stream or moving image file.

### [Eighth Mode]

See the gateway in the second aspect above.

### [Ninth Mode]

See the content distribution method in the third aspect above.

### [Tenth Mode]

See the program in the fourth aspect above.

Each of the eighth mode to the tenth mode described above may be expanded in the same way as the distribution system in the first mode described above is expanded into the second mode to the seventh mode.

### [Eleventh Mode]

The distribution system in the first aspect described above may be configured by the gateway in the second aspect described above, a packet forwarding device that forwards a request message, received from a content requesting terminal, to the gateway, and a content temporary storage device used by the gateway to store a converted moving image stream or moving image file.

### [Twelfth Mode]

The distribution system may further include a radio network control device that selects a radio base station in an area where the content requesting terminal is located and transmits packets, which store the moving image stream or moving image file, to the content requesting terminal.

### First Exemplary Embodiment

Next, a first exemplary embodiment of the present invention will be described in detail below with reference to the drawings.

FIG. 1 is a block diagram showing the connection configuration of the first exemplary embodiment of the present invention. FIG. 1 shows the configuration including a distribution server 120 that distributes content 100, a mobile terminal 170, an RNC(Radio Network Controller) device 195, a gateway 110 connected to an xGSN(Serving/Gateway GPRS Support Node) device 190 on a mobile network 150, and a storage device 125 connected to the gateway 110. In FIG. 1, the solid arrow indicates a data flow and the broken line indicates a control signal flow.

The mobile network 150 may be any one of a mobile packet network, a WiMax(Worldwide Interoperability for Microwave Access) network, and an LTE(Log Term Evolution) network. In the description below, a mobile packet network is assumed.

The distribution server 120 distributes the compression encoded moving image stream or moving file of content, which includes at least one of a moving image, a still image, an audio, and a voice, as the content 100.

The gateway 110, provided on the mobile network 150, receives a connection request message issued from the mobile terminal 170 via the RNC device 195 and the xGSN device 190 and acquires device type information on the mobile terminal included in the connection request message. Although HTTP(Hyper Text Transfer Protocol) is assumed as the protocol for a connection request message, SIP(Session Initiation Protocol) may also be used. The device type information may also be acquired, not from a connection request message, but from a content request message.

The gateway 110 also has the function to acquire the bearer QoS information, which is set in the RNC device 195 by the xGSN device 190, from the xGSN device 195. As the bearer QoS information, the gateway 110 acquires at least one of the maximum bit rate (MBR: Maximum Bit Rate) and the guaranteed bit rate (GBR: Guaranteed Bit Rate).

After acquiring the device type information, the gateway 110 acquires content information specified by the content request message. Next, based on the content information, the gateway 110 checks if a compression encoded moving image stream, which includes content corresponding to the requested content and which can be received by the corresponding device type, or a file that includes such a moving image stream is stored in the storage device 125.

If it is found as the result of the confirmation that a moving image stream or a moving image file that can be received by the content-requesting mobile terminal 170 is stored in the storage device 125, the gateway 110 confirms that the bit rate of the moving image stream or the moving image file does not exceed the maximum bit rate or the guaranteed bit rate. After that, the gateway 110 obtains the moving image stream or moving image file from the storage device 125 and transmits it to the mobile terminal 170 via the xGSN device 190.

On the other hand, if it is found as the result of the confirmation that a moving image stream or a moving image file that can be received by the content-requesting mobile terminal 170 is not stored in the storage device 125 or that the bit rate of the stored moving image stream or moving image file exceeds the maximum bit rate or the guaranteed bit rate, the gateway 110 requests the distribution server 120, via the xGSN device 190, to transmit the content. In addition, the gateway 110 uses the device type information to convert the content to a moving image stream or a moving image file compatible with the ability of the mobile terminal 170 or with the maximum bit rate or the guaranteed bit rate. The gateway 110 then stores the converted moving image stream or moving image file in the storage device 125 and, via the xGSN device 190, transmits it to the mobile terminal 170. In addition to the moving image stream or moving image file transmitted to the mobile terminal 170, the gateway 110 creates another moving image stream or moving image file during the conversion with the encoding condition changed and stores the created image data stream or moving image file in the storage device 125.

The xGSN device 190 forwards the moving image stream or moving image file, output from the distribution server 120, to the gateway 110 using the GTP(GPRS Tunneling Protocol) protocol and outputs the moving image stream or moving image file, output from the gateway 110, to the RNC device 195 via Iu-PS protocol.

The RNC device 195 uses, for example, the TCP/IP protocol to select a radio base station in the area where the mobile terminal 170 is located and transmits the packets, which store the moving image stream or moving image file, to the mobile terminal 170 via the radio base station.

The mobile terminal 170 receives the transmitted moving image file or moving image stream via the mobile network 150 and decodes, reproduces, and displays it. As the wireless function of the mobile terminal 170, not only W-CDMA(Wideband Code Division Multiple Access) and CDMA2000 but also HSDPA(High Speed Downlink Packet Access), HSPA+(High Speed Packet Access), LTE(Long Term Evolution), and WiMax may be used.

Although one gateway 110 is connected to one xGSN device in the configuration shown in the example in FIG. 1, another configuration is also possible in which one gateway 110 is connected to multiple xGSN device for cooperative operation.

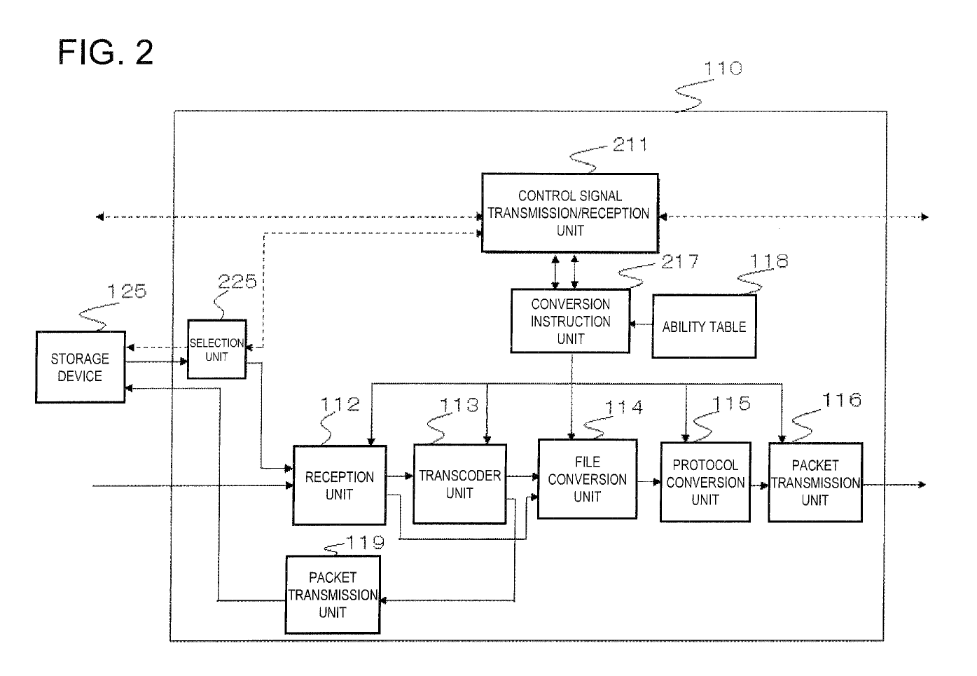

FIG. 2 is a block diagram showing the configuration of the gateway in the first exemplary embodiment of the present invention. Referring to FIG. 2, the gateway 110 in this exemplary embodiment comprises a control signal transmission/reception unit 211, a reception unit 112, a transcoder unit 113, a file conversion unit 114, a protocol conversion unit 115, packet transmission units 116 and 119, a conversion instruction unit 217, an ability table 118, and a selection unit 225. Note that the transcoder unit 113, file conversion unit 114, protocol conversion unit 115, and conversion instruction unit 217 correspond to the conversion unit described above.

The control signal transmission/reception unit 211 receives a request signal, which conforms to a particular protocol, from the mobile terminal 170 via the RNC device 195 and the xGSN device 190. Assume HTTP(Hyper Text Transfer Protocol) is used as the protocol to receive the signal from the mobile terminal 170. When HTTP is used, the control signal transmission/reception unit 211 acquires the device type information from the user agent header and outputs it to the conversion instruction unit 217. As the particular protocol, a known protocol other than HTTP, for example, SDP(Session Description Protocol), may also be used.

The control signal transmission/reception unit 211 has the function to acquire the bearer QoS(Quality of Service) information, which is set in the RNC device 195 by the xGSN device 190, from the xGSN device 190 and outputs the acquired QoS information to the conversion instruction unit 217.

The bearer QoS information on the mobile network 150 includes, for example, the QoS class identifier (QCI: QoS Class Identifier), maximum bit rate (MBR: Maximum Bit Rate), and guaranteed bit rate (GBR: Guaranteed Bit Rate). For example, the control signal transmission/reception unit 211 is assumed to acquire the maximum bit rate (MBR) and the guaranteed bit rate (GBR) in the description below.

The ability table 118, which stores the table of correspondence between terminal device type information and the ability information on the corresponding device type, functions as the ability information storage unit. For example, the table stores the correspondence between each device type and the ability information such as (1) allowable codec, (2) screen resolution, (3) frame rate, (4) maximum receivable bit rate, (5) receivable file format and file size, and (6) reception protocol.

Based on the content information and the device type information specified by the connection request and the request message transmitted from the mobile terminal 170 via which the user selects moving image content the user wants to view, the control signal transmission/reception unit 211 accesses the storage device 125 to check if the storage device 125 stores a compression encoded moving image stream, which includes the specified content and is receivable by the corresponding device type, or a moving image files which includes such a compression encoded moving image stream.

In addition, the control signal transmission/reception unit 211 checks if the bit rate of a compression encoded moving image stream, or a moving image file including such a compression encoded moving image stream, stored in the storage device 125 is equal to or lower than the maximum bit rate (MBR) or the guaranteed bit rate (GBR).

If it is found, as the result of the checking, that the storage device 125 stores at least one of a compression encoded moving image stream, which corresponds to the requested content and device type, or a moving image file, which includes such a compression encoded moving image stream, and that its bit rate is equal to or lower than the maximum bit rate (MBR) or the guaranteed bit rate (GBR), the control signal transmission/reception unit 211 performs the following. That is, the control signal transmission/reception unit 211 instructs the selection unit 225 to select, from those moving image streams or moving image files, the highest-bit-rate moving image stream or moving image file whose bit rate is within the maximum bit rate (MBR) and guaranteed bit rate (GBR), to read selected one from the storage device 125, and to bypass the processing of the transcoder unit 113.

According to the instruction described above (corresponding content is stored), the reception unit 112 receives the moving image stream or moving image file selected by the selection unit 225, extracts the moving image stream or the stream part of the moving image file, bypasses the transcoder unit 113, and outputs the extracted stream to the file conversion unit 114.

According to the above-mentioned “(5) receivable file format and file size” that is the ability information on the mobile terminal 170 output from the conversion instruction unit 217, the file conversion unit 114 generates a file, which has the file format and the file size receivable by the mobile terminal 170, for the moving image stream received from the reception unit 112. An example of the file format is the 3GPP file format, 3GPP2 file format, and MP4 file format. The detail of the 3GPP file format is described, for example, in 3GPP TS26.244 standard.

According to the above-mentioned “(6) reception protocol via which content is received” that is the ability information included in the instruction from the conversion instruction unit 217, the protocol conversion unit 115 determines the protocol via which the mobile terminal 170 can receive content and uses this protocol to output the file, output from the file conversion unit 114, to the packet transmission unit 116. An example of the protocol is RTP/UDP and HTTP/TCP; for example, HTTP/TCP/IP is used according to the instruction from the conversion instruction unit 217.

The packet transmission unit 116 adds an appropriate header to the file, received via the file conversion unit 114 and protocol conversion unit 115, and transmits the file to the xGSN device 190 as packets.

On the other hand, if it is found, as the result of the checking, that the storage device 125 stores neither a compression encoded moving image stream, which corresponds to the requested content and is receivable by the device type, nor a moving image file including such a compression encoded moving image stream or that the storage device 125 stores a compression encoded moving image stream, which corresponds to the requested content and is receivable by the device type, or a moving image file including such a compression encoded moving image stream but its bit rate exceeds the maximum bit rate (MBR) or the guaranteed bit rate (GBR), the control signal transmission/reception unit 211 requests the distribution server 120, via the xGSN device 190, to transmit the content, using a protocol such as SIP (Session Initiation Protocol) or RTSP (Real Time Streaming Protocol).

In response to the request, the distribution server 120 (see FIG. 1) transmits the compression encoded moving image stream or the moving image file corresponding to the requested content to the gateway 110 via the xGSN device 190 using, for example, RTP packets. At this time, the distribution server 120 transmits the information on the content, such as codec used for compression encoding the selected content, video screen resolution, bit rate, frame rate, and whether the content is a stream or a file, to the gateway 110 via the xGSN device 190, using a protocol such as SDP(Session Description Protocol).

The control signal transmission/reception unit 211 outputs the information transmitted from the distribution server 120, such as the information on the codec of the selected content, to the conversion instruction unit 217.

The conversion instruction unit 217 creates a conversion instruction using the ability information read from the ability table 118 and corresponding to the device type information on the terminal output from the control signal transmission/reception unit 211, the information on the content, and the maximum bit rate (MBR) and the guaranteed bit rate (GBR) output from the control signal transmission/reception unit 211 and, after that, outputs the created conversion instruction to each of the processing units.

For example, consider the case in which the information is obtained from the distribution server 120 indicating that the content is compression encoded in MPEG-2 MP (Main Profile) at 8 Mbps with the screen resolution of SD (720×480 pixels) and the frame rate of 30 fps and in which the information is obtained from the ability table 118 indicating that the corresponding device type is able to receive H.264-encoded content at 512 Kbps with the screen resolution of QVGA (320×240 pixels) and the frame rate of 30 fps. At this time, also assume that the information is received indicating that the maximum bit rate is 512 kbps and the guaranteed bit rate is 256 kbps.

First, based on the ability information and the content information described above, the conversion instruction unit 217 creates a conversion instruction to MPEG-2 MP decode the content, to convert the screen resolution from SD to QVGA, and to encode the content into H.264 format at 512 kbps with the frame rate of 30 fps. In addition, considering that the lower of the maximum bit rate (MBR) and the guaranteed bit rate (GBR) is the guaranteed bit rate (GBR) of 256 kbps, the conversion instruction unit 217 changes the bit rate, included in the conversion instruction, from 512 kbps to 256 kbps.

Further, separate to (in addition to) the content to be distributed to the mobile terminal 170, the conversion instruction unit 217 creates conversion instructions by adding changes to the encoding condition and so on. For example, when generating three types of compression encoded moving image streams or moving image files each having a different bit rate and a different frame rate, the conversion instruction unit 217 creates the following conversion instructions. That is, the three types of conversion instructions have the common part, which is used also for the above-described instruction for the content to be distributed, for specifying the MPEG-2 MP decoding of the content, the conversion of the screen resolution from SD to QVGA, and upto the encoding of the content into the destination codec H.264, and the non-common part for specifying the output bit rate and the frame rate as follows: (a) 512 kbps and 30 fps, (b) 256 kbps and 15 fps, and (c) 128 kbps and 15 fps. The conversion instruction unit 217 outputs these three types of conversion instructions to the transcoder unit and so on. In addition, the conversion instruction unit 217 outputs the ability information, read from the ability table 118, to the packet transmission unit 119, file conversion unit 114, protocol conversion unit 115, and packet transmission unit 116.

The combination of conversion instructions described above is not limited to the combination of three types, and the bit rate and/or frame rate of content to be distributed to the mobile terminal 170 need not always be doubled or reduced by half as in the example above. For example, a conversion instruction may be created that increases or decreases the bit rate or frame rate of content, which will be distributed to the mobile terminal 170, by a fixed value or by a fixed percentage. The maximum bit rate (MBR) or the guaranteed bit rate (GBR) may also be used as the maximum of the bit rate, or the average ability information on the mobile terminals of the service may be taken into consideration. It is desirable to create the conversion instructions so that a converted moving image stream or a moving image file can be viewed by a content request from as many device types as possible, but with consideration for the burden of the transcoder unit 113.

The reception unit 112 receives a moving image stream or a moving image file from the distribution server 120 and outputs the received moving image stream or moving image file to the transcoder unit 113. At this time, if the moving image file is distributed from the distribution server 120, the stream stored in the file is extracted. If a moving image stream is distributed from the distribution server 120, the stream stored in the payload of a packet is obtained.

The transcoder unit 113 causes the transcoder to operate in real time according to the conversion instruction from the conversion instruction unit 217, performs conversion for the received stream, and sequentially outputs multiple types of converted streams to the file conversion unit 114 and the packet transmission unit 119.

The packet transmission unit 119 outputs the information (conversion instruction) on content and the device type information received from the conversion instruction unit 217, as well as the converted streams received from the transcoder unit 113, and outputs the content to the storage device 125 in respective packet formats.

The storage device 125 stores the information (conversion instruction) on content and device type information output from the packet transmission unit 119 as well as the converted streams.

On the other hand, the file conversion unit 114 generates a file, which has the file format and file size receivable by the device type of the mobile terminal 170, for a stream that is a moving image stream output from the transcoder unit 113 and that will be transmitted to the mobile terminal 170 (maximum bit rate stream not exceeding the maximum bit rate (MBR) and the guaranteed bit rate (GBR)) according to the above-mentioned “(5) receivable file format and file size” of the ability information on the mobile terminal 170 output from the conversion instruction unit 217, and outputs the generated file to the protocol conversion unit 115. An example of the file format is the 3GPP file format, 3GPP2 file format, MP4 file format, and flash file.

The protocol conversion unit 115 determines the protocol, via which the mobile terminal 170 can receive content, according to the above-mentioned “(6) protocol via which content is received” of the ability information included in the instruction from the conversion instruction unit 217 and, using this protocol, outputs the file, output from the file conversion unit 114, to the packet transmission unit 116. RTP/UDP and HTTP/TCP are available as the protocol and, for example, HTTP/TCP/IP is used according to the instruction from the conversion instruction unit 217.

The packet transmission unit 116 adds an appropriate header to the file, received via the file conversion unit 114 and protocol conversion unit 115, and transmits the file to the xGSN device 190 as packets.

In this exemplary embodiment, the gateway automatically determines the device type of various mobile terminals (for example, mobile phone terminal, PDA, mobile PC, game machine, etc.,) and automatically converts content suitable for the device type (conversion of bit rate, resolution, codec, frame rate, file format, and protocol). This allows the user to implement the service for distributing the same content to various terminals without modifying the mobile terminal.

In this exemplary embodiment, even if access concentrates on popular content, for example, when there are many terminals to which content is to be distributed or when multiple gateways are provided on the network, content converted in advance and stored in the storage device 125 may be distributed. This prevents the problems that the wait time to distribution (TAT) becomes long or that packets are lost due to traffic congestion caused by reduced QoS (Quality of Service) of the mobile network between a distribution server and a terminal.

In this exemplary embodiment, because the gateway 110 and the packet forwarding device on the mobile network 150 work together to maintain the bearer QoS, the bit rate of content that is transmitted to the mobile terminal 170 does not exceed the maximum bit rate or guaranteed bit rate of the bearer that is set by the bearer QoS. This prevents quality from deteriorating due to video freeze on the terminal, long video-update time, and interrupted voice.

Although the information on both the maximum bit rate and the guaranteed bit rate is used in the description of the first exemplary embodiment above, it is of course be possible to use the information on one of them. If the QoS class identifier (QCI: QoS Class Identifier) is acquired as the bearer QoS information, it is also possible to create a conversion instruction in which the bit rate and/or the frame rate is decreased as necessary according to the QCI value.

### Second Exemplary Embodiment

Next, a second exemplary embodiment of the present invention, in which changes are added to the mobile network, will be described in detail below with reference to the drawings.

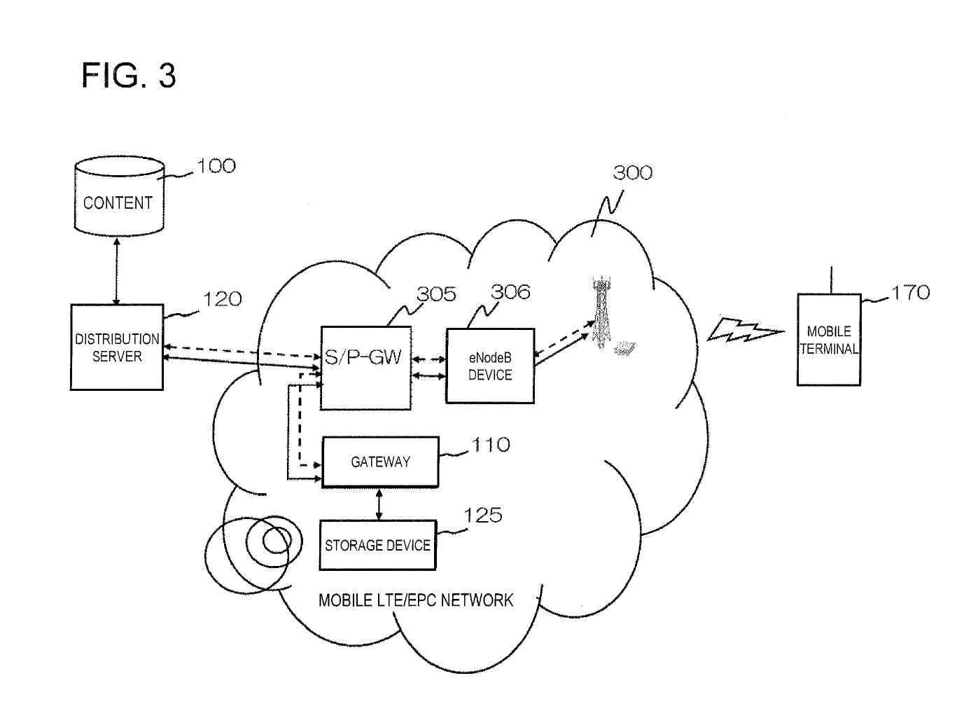

FIG. 3 is a block diagram showing the connection configuration of the second exemplary embodiment of the present invention. In FIG. 3, components having the same reference numerals as those in FIG. 1 are components equivalent to those in the first exemplary embodiment and their description will be omitted. The following describes the difference.

FIG. 3 shows the configuration in which the gateway 110 and the storage device 125 are provided on a mobile LTE(Long Term Evolution)/EPC(Enhanced Packet Core) network 300.

An S/P-GW(Serving/Packet data Gateway) 305 in FIG. 3 serves as a packet forwarding device that performs EPC-technology based, high-speed packet forwarding. More specifically, the S/P-GW 305 receives a moving image stream or moving image file forwarded from the gateway 110 via the protocol, such as the UDP/IP or TCP/TP protocol, in the mobile LTE/EPC network 300, converts its protocol to the GTP-U(GPRS Tunneling Protocol-User Plane)/UDP/IP protocol, and transmits the converted moving image stream or moving image file to an eNodeB (Enhanced-NodeB) device 306.

The eNodeB device 306 in FIG. 3 uses the LTE technology to perform high-speed packet transmission in the radio segment. More specifically, the eNodeB device 306 converts the protocol of the moving image stream or moving image file, transmitted from the S/P-GW 305, to the PDCP(Packet Data Convergence Protocol)/RLC(Radio Link Control), and transmits packets, in which the moving image stream or moving image file is stored, to the mobile terminal 170.

The mobile terminal 170 receives the transmitted moving image stream or moving image file via the mobile LTE/EPC network 300 and then decodes, reproduces, and displays the received moving image stream or moving image file.

Because the S/P-GW 305 and the gateway 110 are connected via the IP protocol, the configuration of the gateway 110 connected to the S/P-GW 305 may be any one of the configurations shown in FIG. 2 and FIG. 3.

Although FIG. 3 shows the configuration in which one gateway is connected to one S/P-GW for cooperation, one gateway may also be connected to multiple S/P-GWs for cooperation.

According to the present invention, the cache of content required by the gateway 110 is automatically created and stored in the content temporary storage device 125 as shown in the exemplary embodiments. Therefore, even when there are many terminals to which content is to be distributed or when access from many terminals concentrates on particular content, content may be distributed suitably according to the ability of individual terminals. In addition, the present invention eliminates the need for a terminal to transmit the screen display ability or attribute information, thus eliminating the need for modifying the terminal.

While the preferred exemplary embodiments of the present invention have been described, it is to be understood that the present invention is not limited to the exemplary embodiments described above and that further modifications, replacements, and adjustments may be added within the scope not departing from the basic technological concept of the present invention. For example, though an example is described in the exemplary embodiment above in which moving image content that is compression encoded is distributed, the present invention may be applied also to content, such as still images and audio signals, using the same configuration.

A known codec other than MPEG-2, for example, H.264 and WMV (Windows (registered trademark) Multimedia Video), may be used as the codec for compression encoding moving image content. In this case, the transcoder unit 113 uses a known codec other than MPEG-4 [sic. 2?], such as H.264, WMV, and so on, as the conversion target-codec.

In addition, a known file format other than 3GPP, for example, 3GPP2 and MP4, may be used as the conversion target-file-format of the file conversion unit 114.

In addition, a known protocol, for example, RTP, may be used as the conversion target-protocol of the protocol conversion unit 115.

The exemplary embodiments may be changed and adjusted in the scope of the entire disclosure (including claims) of the present invention and based on the basic technological concept. In the scope of the claims and drawings of the present invention, various disclosed elements may be combined and selected in a variety of ways. That is, it is apparent that the present invention includes various modifications and changes that may be made by those skilled in the art according to the entire disclosure, including claims, and technological concepts thereof.

### EXPLANATIONS OF SYMBOLS

100 Content
110 Gateway
112 Reception unit
113 Transcoder unit
114 File conversion unit
115 Protocol conversion unit
116,119 Packet transmission unit
118 Ability table
120 Distribution server
125 Storage device
150 Mobile network
170 Mobile terminal
190 xGSN device
195 RNC device
211 Control signal transmission/reception unit
217 Conversion instruction unit
225 Selection unit
300 Mobile LTE/EPC network
305 S/P-GW
306 eNodeB device

1. A gateway, comprising:
an ability information storage unit that stores terminal device type information, included in a content request message, and ability information on an ability of a terminal of the device type to receive moving image content, the device type information being stored in association with the ability information;
a control signal transmission/reception unit that reads a moving image stream or moving image file from a predetermined content temporary storage device based on ability information obtained from device type information and bearer QoS information acquired from a packet forwarding device, the device type information included in a request message received from a content requesting terminal via said packet forwarding device, the moving image stream or moving image file having a bit rate receivable by the content requesting terminal and equal to or lower than a bit rate obtained from the bearer QoS information;
a conversion unit that performs required conversion for a moving image stream or moving image file received from an external distribution server by referencing information stored in said ability information storage unit, the moving image file storing the moving image stream; and
a packet transmission unit that transmits a moving image stream or moving image file read from said predetermined content temporary storage device or converted by said conversion unit, wherein
if said content temporary storage device does not store a moving image stream or moving image file that can be read, said gateway requests said external distribution server to transmit moving image content specified by the request message; instructs said conversion unit to generate a plurality of moving image streams or moving image files including a moving image stream or moving image file which has a bit rate receivable by the content requesting terminal and equal to or lower than a bit rate obtained from the bearer QoS information; transmits the moving image stream or moving image file, which has a bit rate receivable by the content requesting terminal and equal to or lower than a bit rate obtained from the bearer QoS information, to said terminal; and stores the plurality of generated moving image streams or moving image files in said predetermined content temporary storage device.

2. The gateway as defined by claim 1, further comprising a selection unit that selects a moving image stream or moving image file, which has a highest bit rate not exceeding a bit rate obtained from the bearer QoS information, when said control signal transmission/reception unit reads a moving image stream or moving image file, which has a bit rate receivable by the content requesting terminal and equal to or lower than a bit rate obtained from the bearer QoS information, from said predetermined content temporary storage device.

3. The gateway as defined by claim 1, wherein said gateway receives a maximum bit rate and/or a guaranteed bit rate from said packet forwarding device as the bearer QoS information.

4. The gateway as defined by claim 1, wherein the ability information further includes a bit rate, a codec, a screen resolution, and a frame rate receivable by a terminal of the device type, and
a transcoder unit, which generates a stream or a file compatible with the ability information, is provided as said conversion unit.

5. The gateway as defined by claim 1, wherein
the ability information further includes at least one of a file format, a file size, and a protocol receivable by a terminal of the device type, and
a file conversion unit, which performs file conversion, or a protocol conversion unit, which performs protocol conversion, is provided as said conversion unit, the file conversion or the protocol conversion performed to ensure compatibility with the ability information.

6. The gateway as defined by claim 1, wherein
said packet forwarding device is a Serving/Gateway GPRS Support Node (xGSN) device on a mobile packet network or a Serving/Packet Data (S/P) gateway on a mobile Evolved Packet Core (EPC) network.

7. The gateway as defined by claim 1, wherein
as the plurality of moving image streams or moving image files that the gateway instructs said conversion unit to generate if said content temporary storage device does not store a moving image stream or moving image file having a bit rate receivable by the content requesting terminal and equal to or lower than a bit rate obtained from the bearer QoS information,
said gateway instructs said conversion unit to generate:
a moving image stream or moving image file having a bit rate receivable by the content requesting terminal and equal to or lower than a bit rate obtained from the bearer QoS information, and
moving image streams or moving image files each having a bit rate or frame rate different from the bit rate or frame rate of the moving image stream or moving image file.

8. A distribution system, comprising:
the gateway as defined by claim 1; a packet forwarding device that forwards a request message, received from a content requesting terminal, to said gateway; and a content temporary storage device used by said gateway to store a converted moving image stream or moving image file.

9. The distribution system as defined by claim 8, further comprising a radio network control device that selects a radio base station in an area where the content requesting terminal is located and transmits packets, which store the moving image stream or moving image file, to the content requesting terminal.

10. A content distribution method, performed by a gateway that comprises:
an ability information storage unit that stores terminal device type information, included in a content request message, and ability information on an ability of a terminal of the device type to receive moving image content, the device type information being stored in association with the ability information;
a control signal transmission/reception unit that reads a moving image stream or moving image file from a predetermined content temporary storage device based on ability information obtained from device type information and bearer QoS information acquired from a packet forwarding device, the device type information included in a request message received from a content requesting terminal via said packet forwarding device, the moving image stream or moving image file having a bit rate receivable by the content requesting terminal and equal to or lower than a bit rate obtained from the bearer QoS information;
a conversion unit that performs required conversion for a moving image stream or moving image file received from an external distribution server by referencing information stored in said ability information storage unit, the moving image file storing the moving image stream; and
a packet transmission unit that transmits a moving image stream or moving image file read from said predetermined content temporary storage device or converted by said conversion unit,
said content distribution method comprising:
if said content temporary storage device does not store a moving image stream or moving image file that can be read, requesting said external distribution server to transmit moving image content specified by the request message;
instructing said conversion unit to generate a plurality of moving image streams or moving image files including a moving image stream or moving image file which has a bit rate receivable by the content requesting terminal and equal to or lower than a bit rate obtained from the bearer QoS information;
transmitting the moving image stream or moving image file, which has a bit rate receivable by the content requesting terminal and equal to or lower than a bit rate obtained from the bearer QoS information, to said terminal; and
storing the plurality of generated moving image streams or moving image files in said predetermined content temporary storage device.

11. A program, causing a computer, which configures a gateway, to perform processings, said gateway comprising:
an ability information storage unit that stores terminal device type information, included in a content request message, and ability information on an ability of a terminal of the device type to receive moving image content, the device type information being stored in association with the ability information;
a control signal transmission/reception unit that reads a moving image stream or moving image file from a predetermined content temporary storage device based on ability information obtained from device type information and bearer QoS information acquired from a packet forwarding device, the device type information included in a request message received from a content requesting terminal via said packet forwarding device, the moving image stream or moving image file having a bit rate receivable by the content requesting terminal and equal to or lower than a bit rate obtained from the bearer QoS information;
a conversion unit that performs required conversion for a moving image stream or moving image file received from an external distribution server by referencing information stored in said ability information storage unit, the moving image file storing the moving image stream; and
a packet transmission unit that transmits a moving image stream or moving image file read from said predetermined content temporary storage device or converted by said conversion unit,
said program causing said computer to perform the processings of:
if said content temporary storage device does not store a moving image stream or moving image file that can be read, requesting said external distribution server to transmit moving image content specified by the request message;
instructing said conversion unit to generate a plurality of moving image streams or moving image files including a moving image stream or moving image file which has a bit rate receivable by the content requesting terminal and equal to or lower than a bit rate obtained from the bearer QoS information;
transmitting the moving image stream or moving image file, which has a bit rate receivable by the content requesting terminal and equal to or lower than a bit rate obtained from the bearer QoS information, to said terminal; and
storing the plurality of generated moving image streams or moving image files in said predetermined content temporary storage device.

12. The gateway as defined by claim 2, wherein said gateway receives a maximum bit rate and/or a guaranteed bit rate from said packet forwarding device as the bearer QoS information.

13. The gateway as defined by claim 2, wherein the ability information further includes a bit rate, a codec, a screen resolution, and a frame rate receivable by a terminal of the device type and
a transcoder unit, which generates a stream or a file compatible with the ability information, is provided as said conversion unit.

14. The gateway as defined by claim 3, wherein the ability information further includes a bit rate, a codec, a screen resolution, and a frame rate receivable by a terminal of the device type and
a transcoder unit, which generates a stream or a file compatible with the ability information, is provided as said conversion unit.

15. The gateway as defined by claim 2, wherein
the ability information further includes at least one of a file format, a file size, and a protocol receivable by a terminal of the device type and
a file conversion unit, which performs file conversion, or a protocol conversion unit, which performs protocol conversion, is provided as said conversion unit, the file conversion or the protocol conversion performed to ensure compatibility with the ability information.

16. The gateway as defined by claim 3, wherein
the ability information further includes at least one of a file format, a file size, and a protocol receivable by a terminal of the device type and
a file conversion unit, which performs file conversion, or a protocol conversion unit, which performs protocol conversion, is provided as said conversion unit, the file conversion or the protocol conversion performed to ensure compatibility with the ability information.

17. The gateway as defined by claim 4, wherein
the ability information further includes at least one of a file format, a file size, and a protocol receivable by a terminal of the device type and
a file conversion unit, which performs file conversion, or a protocol conversion unit, which performs protocol conversion, is provided as said conversion unit, the file conversion or the protocol conversion performed to ensure compatibility with the ability information.

18. The gateway as defined by claim 2, wherein
as the plurality of moving image streams or moving image files that the gateway instructs said conversion unit to generate if said content temporary storage device does not store a moving image stream or moving image file having a bit rate receivable by the content requesting terminal and equal to or lower than a bit rate obtained from the bearer QoS information,
said gateway instructs said conversion unit to generate
a moving image stream or moving image file having a bit rate receivable by the content requesting terminal and equal to or lower than a bit rate obtained from the bearer QoS information and
moving image streams or moving image files each having a bit rate or frame rate different from the bit rate or frame rate of the moving image stream or moving image file.

19. The gateway as defined by claim 3, wherein
as the plurality of moving image streams or moving image files that the gateway instructs said conversion unit to generate if said content temporary storage device does not store a moving image stream or moving image file having a bit rate receivable by the content requesting terminal and equal to or lower than a bit rate obtained from the bearer QoS information,
said gateway instructs said conversion unit to generate
a moving image stream or moving image file having a bit rate receivable by the content requesting terminal and equal to or lower than a bit rate obtained from the bearer QoS information and
moving image streams or moving image files each having a bit rate or frame rate different from the bit rate or frame rate of the moving image stream or moving image file.

20. The gateway as defined by claim 4, wherein
as the plurality of moving image streams or moving image files that the gateway instructs said conversion unit to generate if said content temporary storage device does not store a moving image stream or moving image file having a bit rate receivable by the content requesting terminal and equal to or lower than a bit rate obtained from the bearer QoS information,
said gateway instructs said conversion unit to generate
a moving image stream or moving image file having a bit rate receivable by the content requesting terminal and equal to or lower than a bit rate obtained from the bearer QoS information and
moving image streams or moving image files each having a bit rate or frame rate different from the bit rate or frame rate of the moving image stream or moving image file.
